(19) United States
(12) Patent Application Publication
(10) Pub. No.: US 2018/0247419 A1
(43) Pub. Date: Aug. 30, 2018

(54) OBJECT TRACKING METHOD

(71) Applicant: GrassWonder Inc., Taipei City (TW)

(72) Inventor: Ching-Kang LEE, Taipei City (TW)

(21) Appl. No.: 15/494,467

(22) Filed: Apr. 22, 2017

(30) Foreign Application Priority Data
Feb. 24, 2017 (TW) 106106334

(51) Int. Cl. G06T 7/246; H04N 5/232; H04N 5/225; G06T 7/73

(52) U.S. Cl. CPC G06T 7/246; H04N 5/23216; H04N 5/23293; H04N 5/23222; G06T 2207/30201; G06T 7/73; G06T 2207/10004; G06T 2207/20092; H04N 5/2251

(57) ABSTRACT

An object tracking method is disclosed. The object tracking method of the present invention is adapted for an object tracking system with an image capture device and a bearing device. In the present invention, the connection between the image capture device and the bearing device is firstly established. A first sample image is captured by the image capture module and an object on the image is selected to be a tracked object. The coordinate of the tracked object is compared with the coordinate of a target location and a control signal is generated according to the difference between the coordinates of the object and the target location. Finally, the control signal is transmitted to the bearing device and the bearing seat is driven by the driving module to rotate or move such that the tracked object is located at the target location.

### FIELD OF THE INVENTION

The present invention is related to an object tracking method, more particularly to an object tracking method adapted for an object tracking system with an image capture device and a bearing device.

### BACKGROUND OF THE INVENTION

As the techniques of the electronics industry are continuously developed, electronic devices, such as smart phones, have become an indispensable part of people's daily lives. A mobile phone with only function of vocal communication has been improved to a smart phone with functions of photographing, voice recording, video recording, etc. Consequently, people use smart phones to take photographs videos instead of using cameras gradually.

In practical use, a smart phone is adapted for handheld using to take photograph or video. If a person wants to take a selfie, the range of the photograph is restricted by the length of his/her arm, and the quality of the photograph is greatly affected by personal skill. Moreover, if a person takes a selfie by an assistant device, such as a selfie stick, the quality of the photograph is also greatly affected by operation skill and stability of the person for the assistant device. Most of the current assistant devices extend the range of the selfies, but the quality of the selfies is also dependent on the operation skill of the users.

Furthermore, how to keep a target (such as a face or an object) in a suitable location of the image is also a problem for a user to operate the assistant device.

Consequently, how to provide an object tracking method to overcome the problems occur during taking a selfie is the problem of the community.

### SUMMARY OF THE PRESENT INVENTION

It is an objective of the present invention to provide an object tracking method, more particularly to an object tracking method adapted for an object tracking system with an image capture device and a bearing device.

It is another objective of the present invention to provide an object tracking method, which captures a sample image, selects an object on the sample image to be a tracked object, calculates the difference between the coordinates of the object and a target location and controls a bearing device to rotate or move such that the tracked object is located at the target location.

It is still another objective of the present invention to provide an object tracking method, which selects an object in an image displayed on a display to be the tracked object to track the object.

It is still another objective of the present invention to provide an object tracking method, which displays a selecting frame on the display, when an object is kept in the selecting frame for a predetermined period, the object is selected to be the tracked object.

It is still another objective of the present invention to provide an object tracking method, which compares a first sample image and a second sample image, if an object has a displacement in the two images, the object is selected to be the tracked object.

The present invention provides an object tracking method, adapted for an object tracking system, wherein the object tracking system comprises an image capture device with an image capture module, a processing unit and a display; and a bearing device with a control module, a driving module and a bearing seat; wherein the image capture device is disposed on the bearing seat; wherein the method comprises: establishing a connection between the image capture device and the bearing device; obtaining a first sample image and displaying the first sample image on the display; selecting an object in the first sample image as a tracked object and obtaining an object coordinate of the tracked object; calculating a difference between the object coordinate and a target coordinate of a target location; generating a first control signal according to the difference and transmitting the first control signal to the bearing device; and controlling the driving module to drive the bearing seat to rotate or move by the control module according to the first control signal so as to move the tracked object to the target location.

In one embodiment of the present invention, the step of selecting the object in the first sample image as the track object and obtaining the object coordinate of the tracked object comprises: selecting the object in the first sample image on the display as the tracked object; obtaining a first coordinate of the tracked object in the first sample image as the object coordinate; and analyzing and recording characteristics of the tracked object.

In one embodiment of the present invention, if the object tracking system is in a multi-object tracking mode, a plurality of objects in the first sample image on the display can be selected to be the tracked objects, and a center coordinate of the plurality of objects is calculated to be the object coordinate.

In one embodiment of the present invention, the step of selecting the object in the first sample image as the tracked object and obtaining the object coordinate of the tracked object comprises: displaying a selecting frame on the display; selecting an object which is kept in the selecting frame for a predetermined period as the tracked object; obtaining a first coordinate of the tracked object in the first sample image as the object coordinate; and analyzing and recording characteristics of the tracked object.

In one embodiment of the present invention, the step of selecting the object in the first sample image as the tracked object and obtaining the object coordinate of the tracked object comprises: obtaining a second sample image by using the image capture module; comparing the first sample image and the second sample image, wherein if an object has a displacement the object is selected to be the tracked object; obtaining a second coordinate of the tracked object in the second sample image as the object coordinate; and analyzing and recording characteristics of the tracked object.

In one embodiment of the present invention, if a plurality of objects have displacements during the comparing of the first sample image and the second sample image, an object having a greatest area is selected as the tracked object.

In one embodiment of the present invention, the method further comprises periodically performing: obtaining a third sample image by using the image capture module; obtaining a third coordinate of the tracked object in the third sample image; calculating a difference between the third coordinate and the target coordinate; generating a second control signal according to the difference and transmitting the second control signal to the bearing device; and controlling the driving module to drive the bearing seat to rotate or move according to the second control signal by the control module so as to move the tracked object to the target location.

In one embodiment of the present invention, the target location is at the center of the display or is determined by a user.

In one embodiment of the present invention, the connection between the image capture device and the bearing device is a wired connection or a wireless connection.

In one embodiment of the present invention, the characteristics of the tracked object comprise a shape, a color, a size and a feature.

In one embodiment of the present invention, the characteristics of the tracked object comprise a shape, a color, a size and a feature.

In one embodiment of the present invention, the characteristics of the tracked object comprise a shape, a color, a size and a feature.

### BRIEF DESCRIPTION OF THE DRAWINGS

FIG. 1 is a schematic diagram of an object tracking system in accordance with one embodiment of the present invention.

FIG. 2 is a flowchart of an object tracking method in accordance with one embodiment of the present invention.

FIG. 3 is a flowchart of an object tracking method in accordance with another embodiment of the present invention.

FIG. 4 is a schematic diagram of a method of selecting an object in accordance with one embodiment of the present invention.

FIG. 5 is a schematic diagram of a method of selecting an object in accordance with another embodiment of the present invention.

FIG. 6 is a schematic diagram of a method of selecting an object in accordance with still another embodiment of the present invention.

### DETAILED DESCRIPTION OF THE PREFERRED EMBODIMENTS

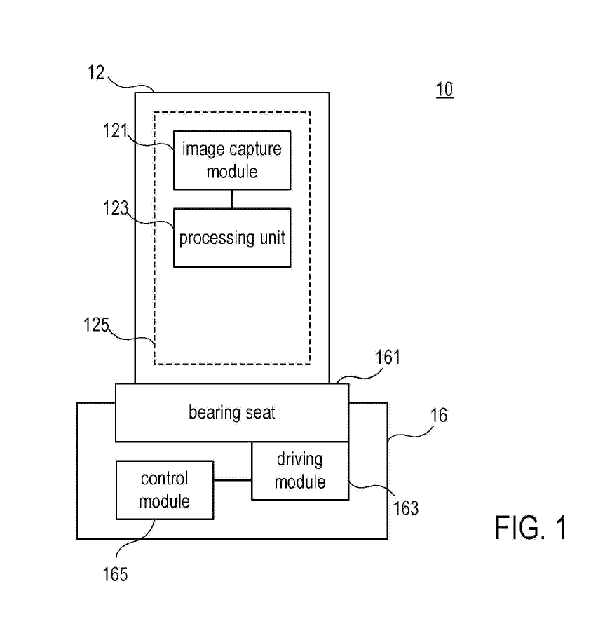

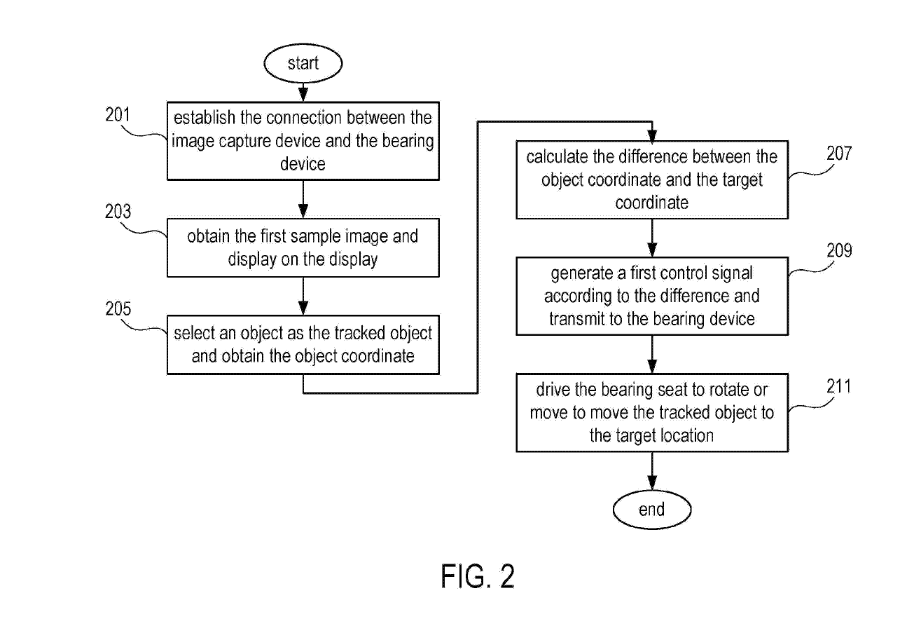

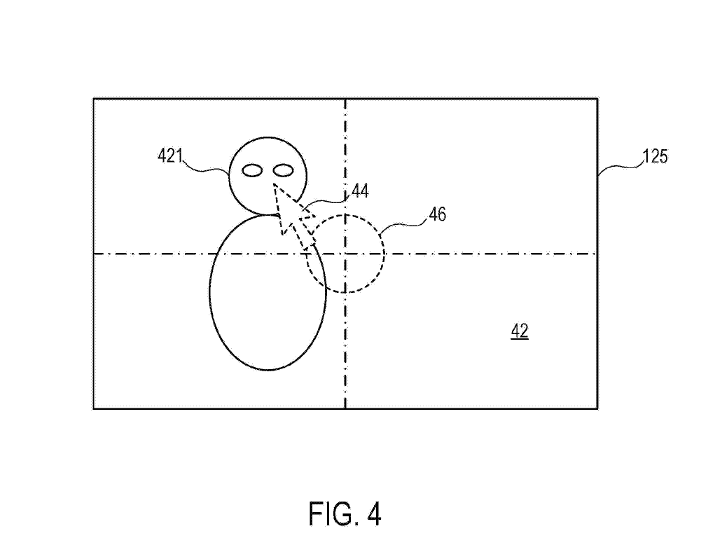

Referring to FIG. 1, FIG. 2 and FIG. 4, there are shown an object tracking system, method and a method of selecting an object in accordance with one embodiment of the present invention. The object tracking method of the present invention is adapted for an object tracking system 10. The object tracking system 10 comprises an image capture device 12 and a bearing device 16. The image capture device 12 comprises an image capture module 121, a processing unit 123 and a display 125. The image capture module 121 is configured to capture an image of a scene. The processing unit 123 is configured to control the operation of the image capture module 121, perform image processing or execute application programs, generate control signal, or establish connection with other device, such as the bearing device 16. The display 125 is configured to display the image captured by the image capture module 121 or image generated by the processing unit 123. The bearing device 16 comprises a control module 165, a driving module 163 and a bearing seat 161. The bearing seat 161 is configured to bear and fix the image capture device 12. The driving module 163 is configured to drive the bearing seat 161 to rotate or move. The control module 165 is configured to control the operation of the bearing device 16, establish the connection with other device, such as the image capture device 12, or receive control signal from other device.

In the method of the present invention, the connection between the image capture device 12 and the bearing device 16 is firstly established, as shown in step 201. The connection between the image capture device 12 and the bearing device 16 is selectively one of a wired connection or a wireless connection. For wired connection, it may be USB connection, serial port connection, I2C connection, I2S connection, audio line connection or other wired connection. For wireless connection, it may be wireless network (Wi-Fi) connection, radio frequency (RF) connection, Bluetooth connection, NFC connection, ZigBee connection or other wireless connection.

After the connection is established, the image capture module 121 of the image capture device 12 is used to obtain a first sample image 42 and the first sample image 42 is displayed on the display 125, as shown in step 203. And then, an object 421 in the first sample image 42 is selected to be the tracked object and the object coordinate of the object 421 in the first sample image 42 is also obtained, as shown in step 205. If the object 421 has an area in the first sample image 42, the object coordinate is determined at the center of the object 421.

In one embodiment of the present invention, a target location 46 can be determined on the display 125. In general, the target location 46 is at the center of the display 125 by default. The target location 46 can also be determined by the user at any location of the display 125. After determining the target location 46, the target coordinate of the target location 46 can also be obtained.

In the method of the present invention, the processing unit 123 of the image capture device 12 calculates the difference between the object coordinate and the target coordinate, generates a first control signal according to the difference and transmits the first control signal to the bearing device 16 by the connection between the image capture device 12 and the bearing device 16, as shown in steps 207 and 209. After receiving the first control signal, the control module 165 of the bearing device 16 controls the driving module 163 to drive the bearing seat 161 to rotate or move according to the first control signal. By rotating or moving the bearing seat 161, the image capture device 12 fixed on the bearing seat 161 is rotated or moved to change the orientation of the image capture module 121 so as to move the tracked object to the target location, as shown in step 211.

In one embodiment of the present invention, the step of selecting an object 421 to be the tracked object comprises: selecting an object 421 in the first sample image 42 shown on the display 125 to be the tracked object; obtaining the first coordinate of the tracked object in the first sample image 42 as the object coordinate; and analyzing and recording the characteristics of the tracked object for object tracking.

To select the object 421 to be the tracked object, a user can move the cursor 44 to the object 421 on the display 125 and click to select. If the display 125 is a touch panel, the user can touch the object 421 directly on the display 125 to select the object 421.

In one embodiment of the present invention, if the object tracking system 10 is in a multi-object tracking mode, a plurality of objects in the first sample image 42 on the display 125 can be selected to be the tracked objects. To track the plurality of objects, the center coordinate of the plurality of objects is obtained to be the object coordinate for tracking.

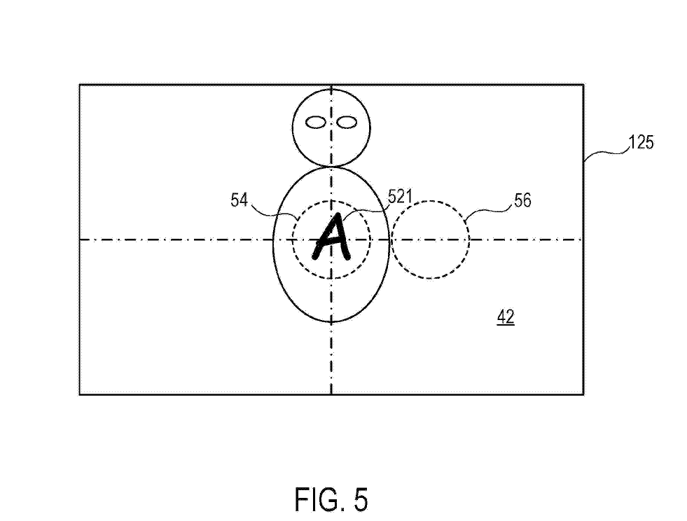

Referring to FIG. 5, there is shown a schematic diagram of a method of selecting an object in accordance with another embodiment of the present invention. In the present embodiment, the step of selecting an object 521 to be the tracked object comprises: displaying a selecting frame 54 on the display 125; rotating or moving the image capture device 12 to keep the object 521 in the selecting frame 54 for a predetermined period; obtaining the first coordinate of the object 521 in the first sample image 42 as the object coordinate; and analyzing and recording the characteristics of the tracked object for tracking.

In one embodiment of the present invention, the object 521 is moved that the object 521 in the first sample image 42 is kept in the selecting frame 54 for the predetermined period to select the object 521 to be the tracked object. In one embodiment of the present invention, the predetermined period is 2-5 seconds or can be determined by the user. In one embodiment of the present invention, the target location 56 is determined by the user at any location of the display 125.

In the present embodiment, the user needn't operate the image capture device 12 to select an object to track.

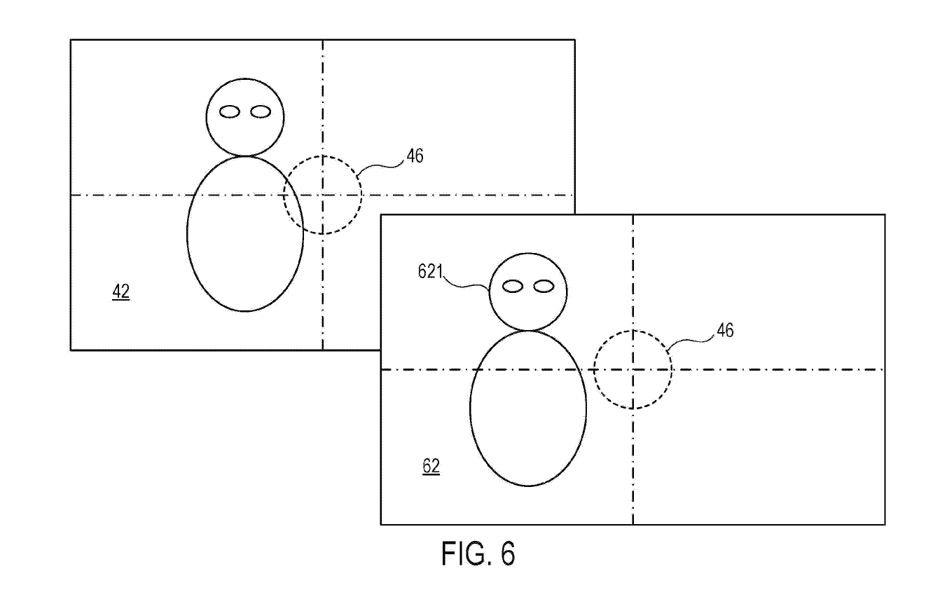

Referring to FIG. 6, there is shown a schematic diagram of a method of selecting an object in accordance with still another embodiment of the present invention. In the present embodiment, the step of selecting an object 621 to be the tracked object comprises: obtaining a second sample image 62 by using the image capture module 121 of the image capture device 12; comparing the first sample image 42 and the second sample image 62, wherein if an object 621 has a displacement the object is selected to be the tracked object; obtaining the second coordinate of the tracked object in the second sample image 62 as the object coordinate; and analyzing and recording the characteristics of the tracked object for tracking.

In one embodiment of the present invention, if a plurality of objects have displacements during the comparing of the first sample image 42 and the second sample image 62, the object having the greatest area is selected to be the tracked object. In the present embodiment, the user needn't operate the image capture device 12 to select an object to track also.

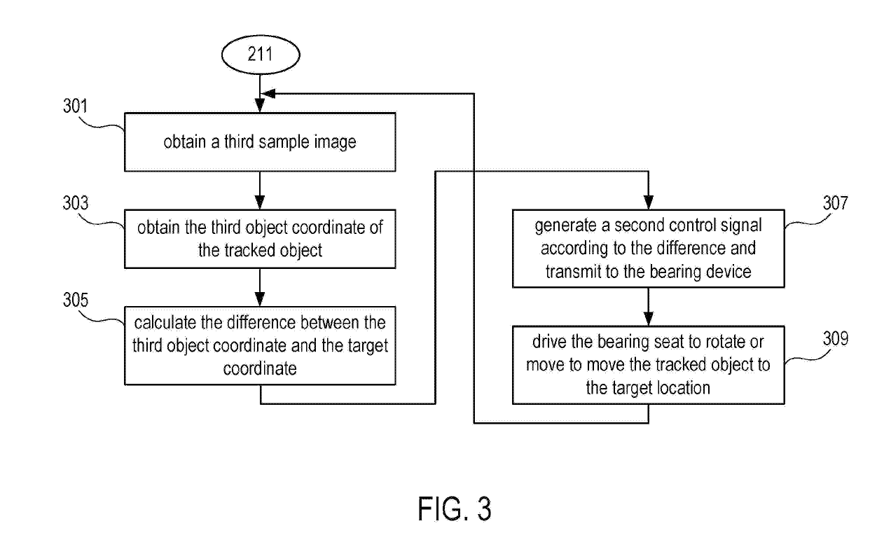

Referring to FIG. 3, there is shown a flowchart of an object tracking method in accordance with another embodiment of the present invention. Referring to FIG. 1 and FIG. 2 also, the method of the present embodiment further comprises a plurality of steps after the method shown in FIG. 2. In the method of the present embodiment, a third sample image is obtained by using the image capture module 121 of the image capture device 12, and then the tracked object in the third sample image is analyzed and the coordinate of the tracked object in the third sample image is obtained as a third object coordinate, as shown in steps 301 and 303. If the third object coordinate is different from the target coordinate, the difference between the third object coordinate and the target coordinate is calculated, a second control signal is generated according to the difference between the third object coordinate and the target coordinate and transmitted to the bearing device by the connection between the image capture device 12 and the bearing device 16, as shown in steps 305 and 307. After the bearing device 16 receives the second control signal, the control module 165 controls the driving module 163 to drive the bearing seat 161 to rotate or move according to the second control signal. By rotating or moving the bearing seat 161, the image capture device 12 fixed on the bearing seat 161 is rotated or moved to change the orientation of the image capture module 121 so as to move the tracked object to the target location, as shown in step 309.

By performing steps 301 to 309 periodically, the tracked object is tracked continuously and kept at the target location.

In one embodiment of the present invention, the characteristics of the tracked object comprise the shape, color, size and feature. The feature is selectively one of Harris corner feature, scale invariant feature transform (SIFT) feature, binary robust independent elementary feature (BRIEF) or oriented fast and rotated BRIEF (ORB).

In one embodiment of the present invention, the image capture device 12 is a camera, a smart phone or a tablet computer.

Although particular embodiments of the invention have been described in detail for purposes of illustration, various modifications and enhancements may be made without departing from the scope of the invention specified by the claims.

What is claimed is:

1. An object tracking method, adapted for an object tracking system, wherein the object tracking system comprises an image capture device with an image capture module, a processing unit and a display; and a bearing device with a control module, a driving module and a bearing seat; wherein the image capture device is disposed on the bearing seat; wherein the method comprises:
establishing a connection between the image capture device and the bearing device;
obtaining a first sample image and displaying the first sample image on the display;
selecting an object in the first sample image as a tracked object and obtaining an object coordinate of the tracked object;
calculating a difference between the object coordinate and a target coordinate of a target location;
generating a first control signal according to the difference and transmitting the first control signal to the bearing device; and
controlling the driving module to drive the bearing seat to rotate or move by the control module according to the first control signal so as to move the tracked object to the target location.

2. The method as claimed in claim 1, wherein the step of selecting the object in the first sample image as the track object and obtaining the object coordinate of the tracked object comprises:
selecting the object in the first sample image on the display as the tracked object;
obtaining a first coordinate of the tracked object in the first sample image as the object coordinate; and
analyzing and recording characteristics of the tracked object.

3. The method as claimed in claim 2, wherein if the object tracking system is in a multi-object tracking mode, a plurality of objects in the first sample image on the display can be selected to be the tracked objects, and a center coordinate of the plurality of objects is calculated to be the object coordinate.

4. The method as claimed in claim 1, wherein the step of selecting the object in the first sample image as the tracked object and obtaining the object coordinate of the tracked object comprises:
displaying a selecting frame on the display;
selecting an object which is kept in the selecting frame for a predetermined period as the tracked object;
obtaining a first coordinate of the tracked object in the first sample image as the object coordinate; and
analyzing and recording characteristics of the tracked object.

5. The method as claimed in claim 1, wherein the step of selecting the object in the first sample image as the tracked object and obtaining the object coordinate of the tracked object comprises:
obtaining a second sample image by using the image capture module;
comparing the first sample image and the second sample image, wherein if an object has a displacement the object is selected to be the tracked object;
obtaining a second coordinate of the tracked object in the second sample image as the object coordinate; and
analyzing and recording characteristics of the tracked object.

6. The method as claimed in claim 5, wherein if a plurality of objects have displacements during the comparing of the first sample image and the second sample image, an object having a greatest area is selected as the tracked object.

7. The method as claimed in claim 1, further comprising periodically performing:
obtaining a third sample image by using the image capture module;
obtaining a third coordinate of the tracked object in the third sample image;
calculating a difference between the third coordinate and the target coordinate;
generating a second control signal according to the difference and transmitting the second control signal to the bearing device; and
controlling the driving module to drive the bearing seat to rotate or move according to the second control signal by the control module so as to move the tracked object to the target location.

8. The method as claimed in claim 1, wherein the target location is at the center of the display or is determined by a user.

9. The method as claimed in claim 1, wherein the connection between the image capture device and the bearing device is a wired connection or a wireless connection.

10. The method as claimed in claim 2, wherein the characteristics of the tracked object comprise a shape, a color, a size and a feature.

11. The method as claimed in claim 4, wherein the characteristics of the tracked object comprise a shape, a color, a size and a feature.

12. The method as claimed in claim 5, wherein the characteristics of the tracked object comprise a shape, a color, a size and a feature.
